(19) United States
(12) Patent Application Publication
(10) Pub. No.: US 2026/0082292 A1
(43) Pub. Date: Mar. 19, 2026

(54) RESOURCE RELEASE METHODS AND APPARATUSES, AND STORAGE MEDIUM

(71) Applicant: Beijing Xiaomi Mobile Software Co., Ltd., Beijing (CN)

(72) Inventors: Yi XIONG, Beijing (CN); Yumin WU, Beijing (CN)

(73) Assignee: Beijing Xiaomi Mobile Software Co., Ltd., Beijing (CN)

(21) Appl. No.: 19/110,284

(22) PCT Filed: Sep. 15, 2022
(86) PCT No.: PCT/CN2022/119163

§ 371 Date: Mar. 10, 2025

(51) Int. Cl. H04W 36/08; H04W 36/00; H04W 76/30

(52) U.S. Cl. CPC H04W 36/08; H04W 36/00835; H04W 76/30

(57) ABSTRACT

A release method and apparatus, and a storage medium. The method includes: receiving a node-to-node message sent by a service node, a source node being a network node that supports communication of a user-side device before a cell change occurs to the user-side device, the service node being a network node that supports communication of the user-side device after a cell change occurs to the user-side device, the user-side device being configured with a mobility operation, and the mobility operation comprising cell group selective activation; and according to the node-to-node message, performing terminal context release.

### CROSS-REFERENCE TO RELATED APPLICATIONS

The present application is a U.S. National Stage of International Application No. PCT/CN2022/119163, filed on Sep. 15, 2022, the disclosure of which is incorporated herein by reference in its entirety for all purposes.

### TECHNICAL FIELD

The present disclosure relates to the field of communication technology, and in particular to a resource release method and apparatus, and a storage medium.

### SUMMARY

According to a first aspect of an embodiment of the present disclosure, a resource release method is provided, which is applied to a source node and includes:
receiving an inter-node message sent by a service node, where the source node is a network node that supports a user side device to perform communication before a cell change occurs in the user side device, the service node is a network node that supports the user side device to perform communication after the cell change occurs in the user side device, the user side device is configured with a mobility operation, and the mobility operation includes selective activation of cell groups; and
performing terminal context release according to the inter-node message.

According to a second aspect of an embodiment of the present disclosure, a resource release method is provided, which is applied to a service node, and includes: sending an inter-node message to a source node;
where the source node is a network node that supports a user side device to perform communication before a cell change occurs in the user side device, the service node is a network node that supports the user side device to perform communication after the cell change occurs in the user side device, the user side device is configured with a mobility operation, the mobility operation includes selective activation of cell groups, and the inter-node message is configured to indicate the source node to perform terminal context release.

According to a third aspect of an embodiment of the present disclosure, a resource release apparatus is provided, which is applied to a source node, and the apparatus includes:
a receiving module, configured to receive an inter-node message sent by a service node, where the source node is a network node that supports a user side device to perform communication before a cell change occurs in the user side device, the service node is a network node that supports the user side device to perform communication after the cell change occurs in the user side device, the user side device is configured with a mobility operation, and the mobility operation includes selective activation of cell groups; and
a first release module, configured to perform terminal context release according to the inter-node message.

According to a fourth aspect of an embodiment of the present disclosure, a resource release apparatus is provided, which is applied to a service node, and the apparatus includes:
a sending module, configured to send an inter-node message to a source node;
where the source node is a network node that supports a user side device to perform communication before a cell change occurs in the user side device, the service node is a network node that supports the user side device to perform communication after the cell change occurs in the user side device, the user side device is configured with a mobility operation, the mobility operation includes selective activation of cell groups, and the inter-node message is configured to indicate the source node to perform terminal context release.

According to a fifth aspect of an embodiment of the present disclosure, a resource release apparatus is provided, including:
a processor; and
a memory configured to instructions executable by the processor;
where the processor is configured to execute steps of the method according to the first aspect, or to execute steps of the method according to the second aspect.

According to a sixth aspect of an embodiment of the present disclosure, there is provided a computer-readable storage medium having stored thereon computer program instructions which, when being executed by a processor, implement the steps of the method according to the first aspect, or execute the steps of the method according to the second aspect.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a schematic diagram showing a communication system according to an illustrative embodiment.

FIG. 2 is a flow chart showing a resource release method according to an illustrative embodiment.

FIG. 3 is a flow chart showing a resource release method according to an illustrative embodiment.

FIG. 4 is a flow chart showing a resource release method according to an illustrative embodiment.

FIG. 5 is a flow chart showing a resource release method according to an illustrative embodiment.

FIG. 6 is a flow chart showing a resource release method according to an illustrative embodiment.

FIG. 7 is a block diagram showing a resource release apparatus according to an illustrative embodiment.

FIG. 8 is a block diagram showing a resource release apparatus according to an illustrative embodiment.

FIG. 9 is a block diagram showing a resource release apparatus according to an illustrative embodiment.

FIG. 10 is a block diagram showing a resource release apparatus according to an illustrative embodiment.

### DETAILED DESCRIPTION

Illustrative embodiments will be described in detail herein, examples of which are shown in the accompanying drawings. When the following description refers to the drawings, the same numbers in different drawings represent the same or similar elements unless otherwise indicated. The embodiments described in the following illustrative embodiments do not represent all embodiments consistent with the present disclosure. Instead, they are merely examples of apparatuses and methods consistent with some aspects of the present disclosure as detailed in the appended claims.

In related art, in a case where a selective activation operation is configured for a user side device, even if a master cell group or a secondary cell group changes for the user side device, the user side device will not delete corresponding cell group selective activation configuration, and thus, the corresponding source node will not release the terminal context of the user side device, which causes resources of a source node to be occupied by the user side device for a long time.

In the related art, conditional handover (CHO), conditional PSCell change (CPC) and conditional PSCell addition (CPA) are proposed. For CHO/CPC/CPA, the terminal must release the CHO/CPC/CPA configuration when completing random access to a target PCell/PSCell. Accordingly, if the network device does not reconfigure and reinitialize CHO /PC/CPA, the terminal will not have the opportunity to continue to perform CHO/CPC/CPA later. Therefore, delay of handover or SCG change will be increased and signal overhead will be increased.

Therefore, selective activation of cell groups in MR-DC is proposed, which enables the subsequent configuration to be executed after the cell group (CG) is changed, without reconfiguring or reinitializing corresponding configuration information of the selective activation of the cell group by the network equipment, thereby reducing the signaling overhead and the interruption duration of the cell group change.

The selective activation of cell groups can enables the subsequent configuration to be still executed after the cell group is changed, without the need for the network to reconfigure or reinitialize the corresponding configuration of the selective activation of cell groups. Therefore, in the selective activation of cell groups, the network device can provide the terminal with a “cell group to be activated”, and the “cell group to be activated” can be activated or deactivated later without re-providing the configuration of the cell group.

In the selective activation of cell groups, the network device can provide the terminal device with a pre-configured candidate target cell group or target cell. The terminal can subsequently activate or deactivate the pre-configured candidate cell group or cell according to the configuration (e.g., an activation message) sent by the network device or a corresponding activation event, without re-providing the configuration of the cell group. Or, it can also be understood that in the selective activation of the cell group, after activating a new cell or cell group, or applying a new cell configuration or cell group configuration, or accessing a new cell or cell group, the terminal device will not delete the corresponding configuration information for the selective activation of the cell group.

The selective activation of cell groups can also be referred to as cell group activation. The cell group activation allows the corresponding configuration information to be still executed after the cell group or cell is changed, without the need for the network to reconfigure or reinitialize the corresponding configuration information of the cell group activation. Therefore, the cell group activation can reduce signaling overhead and the interruption duration of the cell group change. The configuration information of the cell group activation may include: configuration ID, and configuration of the target cell or configuration of the target cell group. In some examples, the configuration information of the cell group activation may also include a trigger condition (which may also be referred to as an execution condition or an activation condition).

In an embodiment, the cell group activation is a mobility management process, including any mobility management process by configuring a cell group activation configuration, in which the terminal device activates or deactivates a corresponding cell or cell group according to signaling sent by the network, criteria specified in a protocol, or autonomously, or the terminal device applies corresponding cell configuration or cell group configuration or accesses a cell or cell group.

In an embodiment, the cell group activation is a mobility management process, including any mobility management process in which corresponding part or all of the configuration information is not deleted or released after the mobility process is performed. Not deleting or releasing the corresponding part or all of the configuration information can also be referred to as retaining the corresponding part or all of the configuration information.

In the present disclosure, the cell group is one or more of a master cell group (MCG) and a secondary cell group (SCG). The MCG includes one or more of a primary cell (PCell) and a secondary cell (SCell). The SCG includes one or more of a primary secondary cell (PSCell) and a secondary cell (SCell).

In the present disclosure, the selective activation of the cell group may include cell selective activation or cell activation, for example, it may include one or more of PCell activation, PSCell activation or SCell activation.

It can be seen from the aforementioned related art that in order to reduce the signaling overhead caused by the change of the master cell group or the secondary cell group and the interruption duration of the change of the master cell group or the secondary cell group, the selective activation configuration is proposed. The selective activation configuration means that the network side device can provide the user side device with cell groups to be activated, that is, after activating the new cell group configuration, the user side device will not delete the corresponding selective activation configuration of the cell groups, and correspondingly, the source node cannot release the terminal context corresponding to the user side device, which results in long-term occupancy of the source node's resources.

In addition, if the source node releases the terminal context of the user side device, it will cause activation failure when the user side device subsequently wishes to activate the source node to support the communication of the user side device. Therefore, how to release the resource occupancy by the user side device at the source node is crucial.

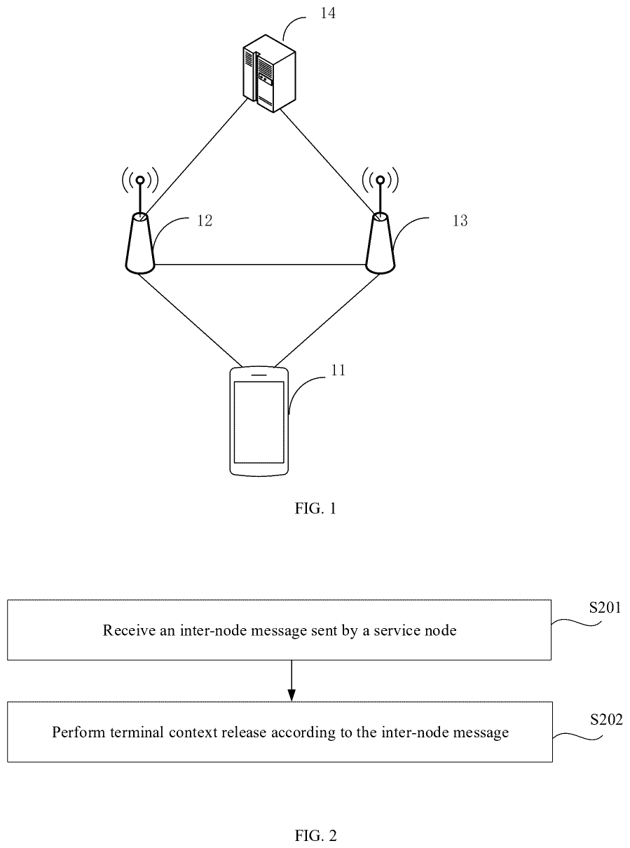

FIG. 1 is a schematic diagram showing a communication system according to an illustrative embodiment. Referring to FIG. 1, the communication system may include a user side device 11, a master node 12, a secondary node 13 and a core network 14. The master node 12 and the secondary node 13 may be base stations.

The user side device 11 can access the master node 12 and the secondary node 13 simultaneously, which is referred to as dual connection. The user side device 11 achieves communication with the core network 14 using radio resources provided by the master node 12 and the secondary node 13.

The master node 12 corresponds to a master cell group, which includes a primary cell (PCell) and multiple secondary cells (SCells). The PCell is the most “primary” cell in the master cell group. The PCell in the master cell group and the SCell in the master cell group are jointed together through carrier aggregation.

The secondary node 13 corresponds to a secondary cell group, which includes a primary secondary cell (PSCell) and multiple secondary cells (SCells).

Many pieces of signaling are sent on PCell and PSCell. For the convenience of description, PCell and PSCell are collectively referred to as special cells (spCell for short) according to the specification of the protocol.

The core network 14 can be an EPC network or a 5GC network.

It is to be noted that, if the connection relationship shown in FIG. 1 is the one before the cell change occurs in the user side device 11, the master node 12 connected with the user side device 11 in FIG. 1 can be called a source master node, and the secondary node 13 connected with the user side device 11 can be called a source secondary node. If the connection relationship shown in FIG. 1 is the one after the cell change occurs in the user side device 11, the master node 12 connected with the user side device 11 in FIG. 1 can be called a service master node, and the secondary node 13 connected with the user side device 11 in FIG. 1 can be called a service secondary node.

FIG. 2 is a flow chart showing a resource release method according to an illustrative embodiment, which is applied to a source node. The source node is a network node that supports the user side device to perform communication before a cell change occurs in the user side device. The source node here can be a source master node and/or a source secondary node. Referring to FIG. 2, the method includes the following steps.

In step S201, an inter-node message sent by a service node is received.

The user side device can be configured with a mobility operation, the mobility operation includes selective activation of a cell group, and the cell group corresponding to the mobility operation is a candidate cell group. When the user side device triggers the mobility operation, the user side device can choose to directly activate the candidate cell group and access the corresponding candidate cell group. The candidate cell group may include a candidate master cell group and/or a candidate secondary cell group. In a case where the cell group newly accessed by the user side device is the master cell group, it can be called that a master cell group change occurs in the user side device, and in a case where the cell group newly accessed by the user side device is the secondary cell group, it can be called that a secondary cell group change occurs in the user side device, that is, the cell change described above may include the master cell group change or the secondary cell group change.

It is to be noted that when the user side device triggers the mobility operation, the user side device may also access other cell groups, where the other cell groups may be not the candidate cell groups.

It is to be noted that the service node is a node that provides services to the user side device after the accessed cell changes in the user side device.

For example, the service node may be a service master node or a service secondary node.

In an embodiment, in a case where the master cell group change occurs in the user side device, the service master node may be a target master node that the user side device accesses.

In an embodiment, in a case where the secondary cell group change occurs in the user side device, the service master node may be the master node to which the user side device is connected, where the master node to which the user side device is connected does not change before and after the secondary cell group change.

In an embodiment, in a case where the secondary cell group change occurs in user side device, the service secondary node may be a target secondary node accessed by the user side device.

In an implementation, the inter-node message may include one or more of a secondary node release request message, a terminal context retrieval confirmation message, a terminal context release message, and a handover request response message.

For example, in response to the UE being configured with the mobility operation, the cell group corresponding to the mobility operation is a candidate cell group (candidate MCG or candidate SCG), where the UE is an example of the user side device herein, the candidate MCG is an example of the candidate master cell group herein, and the candidate SCG is an example of the candidate secondary cell group herein. The mobility operation is selective activation of the cell group, and the source Master Node (MN) or the source Secondary Node (SN) receives UE context release information, where the source MN is an example of the source master node herein, the source SN is an example of the source secondary node herein, and the UE context release information is an example of the terminal context release message herein.

In step S202, terminal context release is performed according to the inter-node message.

For example, the terminal context release refers to releasing radio resource configuration and/or resources of the terminal.

In an embodiment, in response to that the source MN receives the UE context release message sent by a target MN, or that the service MN and/or service MCG of the UE changes, the UE context (terminal context) is released according to a specific criterion, where the target MN is an example of the target master node herein.

In another embodiment, in response to that the source MN receives the UE context release message sent by the service MN, or the service SN and/or service SCG of the UE changes, the UE context is released according to a specific criterion, where the service MN is an example of the service master node herein.

For example, if the source MN is configured with one or more candidate MCGs for the UE, and if the MCG for the UE changes, the source MN retains the UE context and resources corresponding to the candidate MCG(s).

For example, if the source MN is not configured with a candidate MCG for the UE, and if the MCG for the UE changes, the source MN releases all of the UE context.

For example, if the source SN is configured with one or more candidate SCGs for the UE, and if the MCG or SCG for the UE changes, the source SN retains the UE context and resources corresponding to the candidate SCG(s).

For example, if the source SN is configured with one or more candidate SCGs for the UE, and if the MCG or SCG for the UE changes, the source SN retains the UE context and resources corresponding to the candidate SCG(s).

For example, if the source SN is configured with one or more candidate SCGs for the UE, if the MCG or SCG for the UE changes, and if there is an association relationship between the candidate SCG in the source SN and the candidate MCG in the source MN, the source SN does not release the resources corresponding to signaling connection between the source SN and the source MN that is related to the UE.

For example, if the source SN is configured with one or more candidate SCGs for the UE, if the MCG or SCG for the UE changes, and if there is no association relationship between the candidate SCG in the source SN and the candidate MCG in the source MN, the source SN releases only the resources corresponding to the signaling connection between the source SN and the source MN that is related to the UE.

For example, if the source SN is not configured with a candidate SCG for the UE, and if the MCG or SCG for the UE changes, the source SN releases the UE context.

In some embodiments, the candidate SCG is a candidate target cell group corresponding to the mobility operation that is configured by the network device for the UE. When the mobility operation is triggered, the UE accesses the corresponding cell group. The mobility operation is the selective activation of the cell group.

In some embodiments, that there is the association between the candidate MCG and the candidate SCG includes the following situation: the candidate MCG and the candidate SCG are included in the same mobility configuration, for example, included in the same RRC reconfiguration message.

Through the above method, in the case where the user side device is configured with the selective activation of cell groups, the source node receives the inter-node message sent by the service node, and the source node performs the terminal context release according to the inter-node message, thereby reducing the resource occupancy by the user side device at the source node.

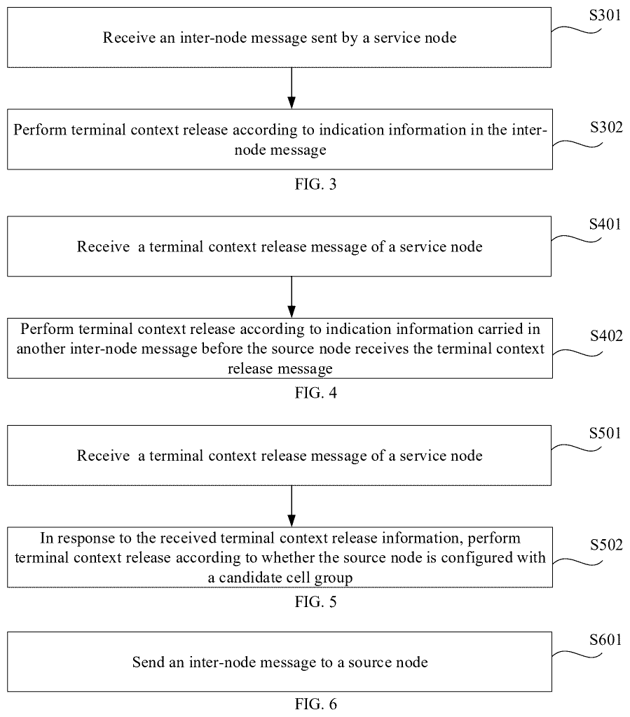

FIG. 3 is a flow chart of a resource release method according to an illustrative embodiment, which is applied in a source node. Referring to FIG. 3, the method includes the following steps.

In step S301, an inter-node message sent by a service node is received.

In step S302, terminal context release is performed according to indication information in the inter-node message.

It is to be noted that step S302 is an implementation of step S202.

The inter-node message may carry indication information, and the indication information may be determined by the service master node. For example, the indication information may be a UE Context Kept Indicator.

The indication information is used to indicate a range of the terminal context to be released, where the range may refer to which parts of the terminal context are released, or may refer to on which cell groups of the source node the terminal context is released. For example, the indication information may be used to indicate at least one of the following.

The indication information is used to indicate whether target terminal context corresponding to the user side device on a source cell group in a source node needs to be released/retained. It is to be noted that the terminal context can include multiple kinds. Therefore, the target terminal context here may refer to one or more kinds of terminal context related to the user side device specified by the core network, or the target terminal context may also refer to one or more kinds of terminal context related to the user side device specified by the protocol. In a case where the source node is a source master node, correspondingly, the source cell group is a source master cell group; and in a case where the source node is a source secondary node, correspondingly, the source cell group is a source secondary cell group.

The indication information is used to indicate whether the terminal context corresponding to the user side device on the source cell group in the source node needs to be released/retained. It can be seen from the foregoing that the terminal context includes one or more kinds, and thus the terminal context here can be all the terminal context related to the user side device.

The indication information is used to indicate whether the terminal context corresponding to the user side device on all candidate cell groups in the source node needs to be released/retained. It can be understood that the source node here is configured with candidate cell groups corresponding to the mobility operation. In a case where the source node is a source master node, the candidate cell group here is a candidate master cell group; and in a case where the source node is a source secondary node, the candidate cell group here is a candidate secondary cell group.

The indication information is used to indicate whether the terminal context corresponding to the user side device on a first target candidate cell group in the source node needs to be released/retained. It can be understood that the source node may include multiple candidate cell groups, and therefore, the first target candidate cell group may be all of the candidate cell groups or part of the multiple candidate cell groups.

The indication information is used to indicate whether to release the UE context related to resources corresponding to the user side device on a source cell in the source node.

The indication information is used to indicate whether a source secondary node releases only the terminal context corresponding to the user side device on a secondary cell group, that is associated with a source master cell group in the source master node, in the source secondary node. It is to be noted that whether the master cell group and the secondary cell group have an association relationship is determined by whether the master cell group and the secondary cell group are included in the candidate cell groups corresponding to the same cell group selective activation. In the case where the master cell group and the secondary cell group are included in the candidate cell groups corresponding to the same cell group selective activation, the master cell group and the secondary cell group have the association relationship (i.e., they are associated with each other); in the case where the master cell group and the secondary cell group are not included in the candidate cell groups corresponding to the same cell group selective activation, the master cell group and the secondary cell group do not have the association relationship (i.e., they are not associated with each other).

The indication information is used to indicate whether the source secondary node releases only the terminal context related to connection with the service node in the source secondary node. It can be seen from the foregoing that the service node can be a target master node, and correspondingly, the indication information here is used to indicate whether the source secondary node releases only the terminal context related to the connection with the target master node in the source secondary node.

In an embodiment, in response to occurring of a MCG change or SCG change, the source MN or the source SN determines how to release the UE context according to whether the received message contains the indication information or a value of the indication information.

For example, the source MN determines how to release the UE context according to inter-node information sent by a target MN to the source MN. The target MN here is an example of the target master node herein.

For example, the source SN determines how to release the UE context according to the inter-node message sent by the MN to the source SN. The MN here is, for example, the master node connected with the user side device herein, and the master node connected with the user side device does not change before and after the secondary cell group is changed.

In an embodiment, the MN sends the indication information to the source SN or the target MN sends the indication information to the source MN, and the indication information is used to indicate whether the source SN needs to retain or release the UE context. The MN here is, for example, the master node connected with the user side device herein, and the master node connected with the user side device does not change before and after the secondary cell group is changed.

In an embodiment, the indication information included in the inter-node information may also be used to indicate one or more of the following.

To indicate whether part of the UE context needs to be retained (or released) or not.

To indicate whether all the UE context needs to be retained (or released) or not.

To indicate whether the resources and UE context corresponding to all or part of the candidate cell groups needs to be retained (or released) or not.

To indicate whether to release only the UE context related to the resources corresponding to the source cell group or not.

To indicate whether the SN releases only the UE context related to resources corresponding to the SCG associated with the source MCG or not.

To indicate whether the SN releases only the UE context related to connection with a transmitting MN. The transmitting MN here is, for example, the target master node, or the master node to which the user side device is connected that is not changed before and after the secondary cell group is changed.

In an embodiment, in response to receiving UE context release information, a receiving node determines whether to release the UE context and how to release the UE context based on whether there is indication information in the corresponding inter-node information or content of the indication information. The receiving node here is, for example, the source MN or source SN herein.

For example, in response to that the source SN receives a message carrying indication information which is configured to be a specific value indicating the source SN to release only the UE context related to the connection with the transmitting MN, after receiving the UE context release message sent by the transmitting MN, the source SN releases only the UE context related to the connection with the transmitting MN in the source SN, and retains the other UE context.

In an implementation, this indication information indicates whether the source MN or source SN needs to retain the UE context in a case where the MN node handover or the SN node change occurs. The MN node handover here is, for example, the master cell group change herein, and the SN node handover here is, for example, the secondary cell group change herein.

For example, this indication information is applicable to whether the source MN or source SN needs to retain the UE context in a case where the cell group selective activation is configured and the MN node handover or SN node change occurs.

In an embodiment, the indication information may be included in the inter-node message such as an SN release request message, a UE context retrieval confirmation message, a UE context release message, a handover request response message, etc. The SN release request message here is the secondary node release request message herein.

For example, the indication information may be a UE Context Kept Indicator, however, it should be understood that other indication information is also possible.

In some embodiments, the candidate SCG is a candidate target cell group corresponding to the mobility operation configured by the network device for the UE, and when the mobility operation is triggered, the UE accesses the corresponding cell group. The mobility operation is cell group selective activation.

In some embodiments, that there is the association between the candidate MCG and the candidate SCG includes the following situation: the candidate MCG and the candidate SCG are included in the same mobility configuration, for example, included in the same RRC reconfiguration message. In the above manner, the range of the terminal context to be released can be determined based on the indication information in the inter-node message, and the resource release is performed according to the terminal context that needs to be released as indicated by the indication information, thereby reducing the resource occupancy by the user side device at the source node.

In some embodiments, the method further includes: performing the terminal context release according to indication information carried in another inter-node message before the source node receives the inter-node message. The terminal context release according to the indication information carried in the other inter-node message is illustrated below by taking an example where the inter-node message is a terminal context release message.

FIG. 4 is a flow chart of a resource release method according to an illustrative embodiment, which is applied to a source node. The inter-node message in step S201 can be a terminal context release message. On this basis, referring to FIG. 4, the method includes the following steps.

In step S401, a terminal context release message of a service node is received.

In step S402, terminal context release is performed according to indication information carried in another inter-node message before the source node receives the terminal context release message.

It is to be noted that step S401 is an implementation of step S201.

The terminal context release message does not carry indication information, but the service node may send the indication information before sending the terminal context release message, that is, another inter-node message sent before the terminal context release message is sent carries the indication information.

In an implementation, the other inter-node message may be at least one of a secondary node release request message, a UE context retrieval confirmation message, or a handover request response message.

In the above manner, after the inter-node message which is the terminal context release message is received, the terminal context release can be performed according to the indication information carried in the other inter-node messages sent before the terminal context release message is sent, thereby reducing the resource occupancy by the user side device at the source node.

In some embodiments, the source node is a source secondary node, and the cell groups corresponding to the mobility operation (i.e., the candidate cell groups) include a candidate master cell group and a candidate secondary cell group. If a first preset condition is met, the indication information is used to indicate the source secondary node to release only the terminal context of the user side device in the source secondary node that is related to the connection with the service master node.

As can be seen from the foregoing, that the cell groups corresponding to the same mobility operation include the candidate master cell group and the candidate secondary cell group is used to indicate that there is an association relationship between the candidate master cell group and the candidate secondary cell group.

The service node may be a service master node, and the first preset condition includes that the service master node is not configured with a candidate master cell group of the candidate cell groups, or the service master node is configured with a candidate master cell group of the candidate cell groups and the source secondary node is not a secondary node corresponding to the candidate secondary cell group associated with the candidate master cell group of the candidate cell groups.

In an implementation, the indication information may be carried in the secondary node release request message. After receiving the secondary node release request message, the source secondary node performs the terminal context release according to the indication information in the secondary node release request message.

In an implementation, after receiving the terminal context release message, the source secondary node performs the terminal context release according to the indication information in the secondary node release request message, where the secondary node release request message may be an inter-node message received before the terminal context release message is received.

In an implementation, in the case where the master cell group change occurs in the user side device, the service master node may be a target master node, that is, the target master node sends the secondary node release request message or the terminal context release message to the source secondary node.

In an implementation, in the case where the secondary cell group change occurs in the user side device, the service master node is the master node connected with the user side device that is not changed before and after the secondary cell group change, and the master node sends the secondary node release request message or the terminal context release message to the source secondary node.

Through the above method, it can be ensured that the joint configuration of the MCG and SCG is available subsequently, while there will not be waste of resources due to retaining all the resources.

In some embodiments, the source node is a source secondary node, and the cell groups corresponding to the mobility operation (i.e., the candidate cell groups) include a candidate master cell group and a candidate secondary cell group. In a case where a second preset condition is met, the service node does not need to send the terminal context release message or the secondary node release request message to the source secondary node.

As can be seen from the foregoing, that the cell groups corresponding to the same mobility operation include the candidate master cell group and the candidate secondary cell group is used to indicate that there is an association relationship between the candidate master cell group and the candidate secondary cell group.

The service node may be a service master node, and the second preset condition includes that the service master node is configured with the candidate master cell group of the candidate cell groups, and the source secondary cell group in the source secondary node is a candidate secondary cell group associated with the candidate master cell group of the candidate cell groups.

In an implementation, in the case where the master cell group change occurs in the user side device, the service master node may be a target master node, that is, the target master node does not need to send the terminal context release message or the secondary node release request message to the source secondary node.

In an implementation, in the case where the secondary cell group change occurs in the user side device, the service master node may be a master node connected with the user side device that is not changed before and after the secondary cell group change. The master node does not need to send the terminal context release message or the secondary node release request message to the source secondary node.

Through the above method, in the case where the second preset condition is met, indicating that the source secondary node is configured with the cell group corresponding to the mobility operation, correspondingly, the candidate secondary cell group in the source secondary node needs to be able to support UE access, and therefore, the terminal context corresponding to the user side device in the source secondary node can be retained, that is, the source secondary node does not need to release the terminal context, and thus, the service master node does not need to send to the source secondary node the terminal context release message or the secondary node release request message that is used to indicate the source secondary node to perform the terminal context release.

In some embodiments, the source node is a source secondary node, and the cell groups corresponding to the mobility operation (i.e., the candidate cell groups) include a candidate master cell group and a candidate secondary cell group. In a case where a third preset condition is met, the indication information is used to indicate the source secondary node to release the terminal context corresponding to the user side device in the source secondary cell group in the source secondary node.

As can be seen from the foregoing, that the cell groups corresponding to the same mobility operation include the candidate master cell group and the candidate secondary cell group is used to indicate that there is an association relationship between the candidate master cell group and the candidate secondary cell group.

The third preset condition includes that the service master node is configured with the candidate master cell group of the candidate cell groups, the source secondary node is a secondary node corresponding to a candidate secondary cell group associated with the candidate master cell group, and the source secondary cell group in the source secondary node is not the candidate secondary cell group associated with the candidate master cell group.

In an implementation, the indication information may be carried in the secondary node release request message. After receiving the secondary node release request message, the source secondary node performs the terminal context release according to the indication information in the secondary node release request message.

In an implementation, in the case where the master cell group change occurs in the user side device, the service master node may be the target master node, that is, the target master node sends the inter-node message carrying the indication information to the source secondary node.

In an implementation, in the case where the secondary cell group change occurs in the user side device, the service master node may be the master node connected with the user side device that is not changed before and after the secondary cell group change, and the master node sends the inter-node message carrying the indication information to the source secondary node.

Through the above method, it can be ensured that the joint configuration of MCG and SCG is available subsequently, and the source SN releases only the UE context related to the SCG that is not the candidate cell group, which will not affect the selective activation configuration of the cell group, while there will not be waste of resources due to retaining all the resources.

In some embodiments, the cell group corresponding to the mobility operation is the candidate cell group, and the above step of performing the terminal context release according to the inter-node message may include: in response to the received inter-node message, performing the terminal context release according to whether the source node is configured with the candidate cell group. The performing the terminal context release according to whether the source node is configured with the candidate cell group is illustrated below by taking an example in which the inter-node message is the terminal context release information.

FIG. 5 is a flow chart of a resource release method according to an illustrative embodiment, which is applied to a source node. Referring to FIG. 5, the method includes the following steps.

In step S501, terminal context release information sent by a service node is received.

In step S502, in response to the received terminal context release information, terminal context release is performed according to whether the source node is configured with a candidate cell group.

It is to be noted that step S501 is an implementation of step S201. Step S502 is an implementation of step S202.

The source node here may include a source master node and/or a source secondary node, the source node is a network node that supports the user side device to perform communication before a cell change occurs in the user side device, and the service node is a network node that supports the user side device to perform communication after the cell change occurs in the user side device. The user side device may be configured with a mobility operation, the mobility operation includes selective activation of a cell group, and the cell group corresponding to the mobility operation is a candidate cell group. When the user side device triggers the mobility operation, the user side device may choose to directly activate the candidate cell group and access the corresponding candidate cell group. The candidate cell group may include a candidate master cell group and/or a candidate secondary cell group. In a case where the cell group newly accessed by the user side device is the master cell group, it may be said that a master cell group change occurs in the user side device, and in a case where the cell group newly accessed by the user side device is the secondary cell group, it may be said that a secondary cell group change occurs in the user side device, that is, the cell change described above may include a master cell group change or a secondary cell group change.

It is to be noted that when the user side device triggers a mobility operation, the user side device may also access other cell groups, where the other cell groups may not be the candidate cell groups.

It is to be noted that the service node is a node that provides services to the user side device after the cell accessed by the user side device changes.

For example, the service node may be a service master node or a service secondary node.

In an embodiment, in a case where a master cell group change occurs in the user side device, the service master node may be a target master node accessed by the user side device.

In an embodiment, in a case where a secondary cell group change occurs in the user side device, the service master node may be a master node connected with the user side device, where the master node connected with the user side device does not change before and after the secondary cell group change.

In an embodiment, in a case where a secondary cell group change occurs in the user side device, the serving secondary node may be a target secondary node accessed by the user side device.

Through the above method, in the case where the terminal context release information does not carry indication information and the inter-node message before the terminal context release information is sent does not carry indication information, after the source node receives the terminal context release information, the source node can perform the terminal context release according to whether it is configured with the candidate cell group. In this way, the purpose of reducing the resource occupancy by the user side device at the source node is achieved, and the practicality of the resource release method provided by the present disclosure is improved.

In some embodiments, the source node includes a source master node, the cell change includes a master cell group change, and the candidate cell group includes multiple candidate master cell groups. In this case, step S502 can be implemented in the following manner: in response to the received terminal context release information, in the case where the master cell group change occurs in the user side device and the source master node is configured with at least one candidate master cell group, the terminal context corresponding to the user side device on the candidate master cell group in the source master node is retained.

Through the above method, since the source master node is configured with at least one candidate master cell group, correspondingly, the candidate master cell group of the source master node needs to support UE access, and thus the terminal context corresponding to the user side device on the candidate master cell group in the source master node can be retained, thereby solving the problem of activation failure when the user side device wishes to activate the candidate master cell group on the source master node, and ensuring the success rate of cell group activation.

In some embodiments, the source node includes a source master node, the cell change includes a master cell group change, and the candidate cell group includes multiple candidate master cell groups. In this case, step S502 can be implemented in the following manner: in response to the received terminal context release information, in a case where the master cell group change occurs in the user side device and the source master node is not configured with at least one candidate master cell group, the terminal context corresponding to the user side device in the source master node is released.

Through the above method, since the source master node is not configured with at least one candidate master cell group, correspondingly, the source master node thus does not need to support UE access. Therefore, there is no need to retain the terminal context corresponding to the user side device in the source master node. Instead, the terminal context corresponding to the user side device in the source master node is directly released, thereby achieving the purpose of reducing the resource occupancy by the user side device in the source master node.

In some embodiments, the source node includes a source secondary node, the cell change includes a master cell group change and a secondary cell group change, and the candidate cell group includes multiple candidate secondary cell groups. In this case, step S502 can be implemented in the following manner: in response to the received terminal context release information, in a case where the master cell group change occurs in the user side device and the source secondary node is configured with at least one candidate secondary cell group, the terminal context corresponding to the user side device on the candidate secondary cell group in the source secondary node is retained.

Through the above method, since the source secondary node is configured with at least one candidate secondary cell group, correspondingly, the source secondary node needs to support UE access, and thus the terminal context corresponding to the user side device on the candidate secondary cell group in the source secondary node is retained, thereby solving the problem of activation failure when the user side device wishes to activate the candidate secondary cell group on the source secondary node, and ensuring the success rate of cell group activation.

In some embodiments, the source node includes a source secondary node, the cell change includes a master cell group change and a secondary cell group change, and the candidate cell group includes multiple candidate secondary cell groups. In this case, step S502 can be implemented in the following manner: in response to the received terminal context release information, in a case where the secondary cell group change occurs in the user side device and the source secondary node is configured with at least one candidate secondary cell group, the terminal context corresponding to the user side device on the candidate secondary cell group in the source secondary node is retained.

Through the above method, since the source secondary node is configured with at least one candidate secondary cell group, correspondingly, the source secondary node needs to support UE access, and thus the terminal context corresponding to the user side device on the candidate secondary cell group in the source secondary node is retained, thereby solving the problem of activation failure when the user side device wishes to activate the candidate secondary cell group on the source secondary node, and ensuring the success rate of cell group activation.

In some embodiments, the source node includes a source secondary node, the cell change includes a master cell group change and a secondary cell group change, and the candidate cell group includes multiple candidate secondary cell groups. In this case, step S502 can be implemented in the following manner: in response to the received terminal context release information, in a case where the master cell group change occurs in the user side device and the candidate secondary cell group in the source secondary node has an association relationship with the candidate master cell group in the source master node, the terminal context corresponding to signaling connection between the source secondary node and the source master node that is related to the user side device in the source secondary node is retained.

In a case where the candidate master cell group and the candidate secondary cell group are included in the cell groups corresponding to the same cell group selective activation, there is an association relationship between the candidate master cell group and the candidate secondary cell group (that is, they are associated with each other); and in a case where the candidate master cell group and the candidate secondary cell group are not included in the cell groups corresponding to the same cell group selective activation, there is no association relationship between the candidate master cell group and the candidate secondary cell group (that is, they are not associated with each other).

Through the above method, the joint configuration of MCG and SCG can be guaranteed to be available subsequently.

In some embodiments, the source node includes a source secondary node, the cell change includes a master cell group change and a secondary cell group change, and the candidate cell group includes multiple candidate secondary cell groups. In this case, step S502 can be implemented in the following manner: in response to the received terminal context release information, in a case where the secondary cell group change occurs in the user side device and the candidate secondary cell group in the source secondary node has an association relationship with the candidate master cell group in the source master node, the terminal context corresponding to signaling connection between the source secondary node and the source master node that is related to the user side device in the source secondary node is retained.

For determining whether there is the association relationship between the candidate master cell group and the candidate secondary cell group, reference can be made to the above related embodiments, which will not be described in detail in this embodiment here.

Through the above method, the joint configuration of MCG and SCG can be guaranteed to be available subsequently.

In some embodiments, the source node includes a source secondary node, the cell change includes a master cell group change and a secondary cell group change, and the candidate cell group includes multiple candidate secondary cell groups. In this case, step S502 can be implemented in the following manner: in response to the received terminal context release information, in a case where the master cell group change occurs in the user side device and there is no association relationship between the candidate secondary cell group in the source secondary node and the candidate master cell group in the source master node, only the terminal context corresponding to the signaling connection between the source secondary node and the source master node that is related to the user side device in the source secondary node is released.

For determining whether there is an association relationship between the candidate master cell group and the candidate secondary cell group, reference can be made to the above related embodiments, which will not be described in detail in this embodiment here.

Through the above method, only the terminal context corresponding to the signaling connection between the source secondary node and the source master node that is related to the user side device in the source secondary node is released, which will not affect the selective activation configuration of the cell group, and at the same time, there will not be waste of resources due to retaining all the resources.

In some embodiments, the source node includes a source secondary node, the cell change includes a master cell group change and a secondary cell group change, and the candidate cell group includes multiple candidate secondary cell groups. In this case, step S502 can be implemented in the following manner: in response to the received terminal context release information, in a case where the secondary cell group change occurs in the user side device and there is no association relationship between the candidate secondary cell group in the source secondary node and the candidate master cell group in the source master node, only the terminal context corresponding to the signaling connection between the source secondary node and the source master node that is related to the user side device in the source secondary node is released.

For determining whether there is an association relationship between the candidate master cell group and the candidate secondary cell group, reference can be made to the above related embodiments, which will not be described in detail in this embodiment here.

Through the above method, only the terminal context corresponding to the signaling connection between the source secondary node and the source master node that is related to the user side device in the source secondary node is released, which will not affect the selective activation configuration of the cell group, and at the same time, there will not be waste of resources due to retaining all the resources.

In some embodiments, the source node includes a source secondary node, the cell change includes a master cell group change and a secondary cell group change, and the candidate cell group includes multiple candidate secondary cell groups. In this case, step S502 can be implemented in the following manner: in response to the received terminal context release information, in a case where the master cell group change occurs in the user side device and the source secondary node is not configured with at least one candidate secondary cell group, the terminal context corresponding to the user side device in the source secondary node is released.

Through the above method, since the source secondary node is not configured with at least one candidate secondary cell group, correspondingly, the source secondary node does not need to support UE access, and therefore, the terminal context corresponding to the user side device in the source secondary node does not need to be retained, and the terminal context corresponding to the user side device in the source secondary node can be released, thereby reducing the resource occupancy by the user side device in the source secondary node.

In some embodiments, the source node includes a source secondary node, the cell change includes a master cell group change and a secondary cell group change, and the candidate cell group includes multiple candidate secondary cell groups. In this case, step S502 can be implemented in the following manner: in response to the received terminal context release information, in a case where the secondary cell group change occurs in the user side device and the source secondary node is not configured with at least one candidate secondary cell group, the terminal context corresponding to the user side device in the source secondary node is released.

Through the above method, since the source secondary node is not configured with at least one candidate secondary cell group, correspondingly, the source secondary node does not need to support UE access, and therefore, the terminal context corresponding to the user side device in the source secondary node does not need to be retained, and the terminal context corresponding to the user side device in the source secondary node can be released, thereby reducing the resource occupancy by the user side device in the source secondary node.

FIG. 6 is a flow chart showing a resource release method according to an illustrative embodiment. The resource release method is applied to a service node and includes the following steps.

In step S601, an inter-node message is sent to a source node, where the inter-node message is used to indicate the source node to perform terminal context release.

The source node here may include a source master node and/or a source secondary node. The source node is a network node that supports the user side device to perform communication before a cell change occurs in the user side device, and the service node is a network node that supports the user side device to perform communication after the cell change occurs in the user side device.

The user side device can be configured with a mobility operation, and the mobility operation includes selective activation of cell groups. The cell group corresponding to the mobility operation is a candidate cell group. When the user side device triggers the mobility operation, the user side device can choose to directly activate the candidate cell group and access the corresponding candidate cell group. The candidate cell group may include a candidate master cell group and/or a candidate secondary cell group. In a case where the cell group newly accessed by the user side device is the master cell group, it can be called that a master cell group change occurs in the user side device, and in a case where the cell group newly accessed by the user side device is the secondary cell group, it can be called that a secondary cell group change occurs in the user side device, that is, the above cell change may include a master cell group change or a secondary cell group change.

It is to be noted that when the user side device triggers the mobility operation, the user side device may also access other cell groups, where the other cell groups may not be the candidate cell groups.

It is to be noted that the service node is a node that provides services to the user side device after the cell accessed by the user side device changes.

For example, the service node may be a service master node or a service secondary node.

In an embodiment, in a case where the master cell group change occurs in the user side device, the service master node may be a target master node accessed by the user side device.

In an embodiment, in a case where the secondary cell group change occurs in the user side device, the service master node may be a master node connected with the user side device, where the master node connected with the user side device does not change before and after the secondary cell group change.

In an embodiment, in a case where the secondary cell group change occurs in the user side device, the service secondary node may be a target secondary node accessed by the user side device. The terminal context release refers to releasing radio resource configuration and/or resources of the terminal.

In an implementation, the service master node may send an inter-node message to the source node in response to a cell change occurring in the user side device.

In an implementation, the inter-node message may include one of a secondary node release request message, a terminal context retrieval confirmation message, a terminal context release message, or a handover request response message.

Through the above method, the service node can respond to the cell change occurring in the user side device that is configured with selective activation of the cell group and send an inter-node message to the source node so that the source node can perform the terminal context release according to the inter-node message, thereby reducing the resource occupancy by the user side device at the source node.

In some embodiments, the inter-node message may carry indication information, where the indication information is determined by the service master node. For example, the indication information may be a UE Context Kept Indicator.

The indication information is used to indicate a range of the terminal context to be released, where the range may refer to which parts of the terminal context are released, or may refer to which cell groups of the source node on which the terminal context is released. For example, the indication information may be used to indicate at least one of the following.

The indication information is used to indicate whether target terminal context corresponding to the user side device on a source cell group in the source node needs to be released/retained. It is to be noted that the terminal context can include multiple kinds. Therefore, the target terminal context here may refer to one or more kinds of the terminal context related to the user side device that are specified by the core network, or the target terminal context may also refer to one or more kinds of the terminal context related to the user side device that are specified by the protocol. In a case where the source node is a source master node, correspondingly, the source cell group is a source master cell group; and in a case where the source node is a source secondary node, correspondingly, the source cell group is a source secondary cell group.

The indication information is used to indicate whether the terminal context corresponding to the user side device on a source cell group in the source node needs to be released/retained. As can be seen from the foregoing, the terminal context includes one or more kinds, so the terminal context here can be all the terminal context related to the user side device.

The indication information is used to indicate whether the terminal context corresponding to the user side device on all candidate cell groups in the source node needs to be released/retained. It can be understood that the source node here is configured with the candidate cell groups corresponding to the mobility operation. In a case where the source node is a source master node, the candidate cell group here is a candidate master cell group; and in a case where the source node is a source secondary node, the candidate cell group here is a candidate secondary cell group.

The indication information is used to indicate whether the terminal context corresponding to the user side device on a first target candidate cell group in the source node needs to be released/retained. It can be understood that the source node may include multiple candidate cell groups, and therefore, the first target candidate cell group may be all candidate cell groups or part of the multiple candidate cell groups.

The indication information is used to indicate whether to release the UE context related to resources corresponding to the user side device on a source cell in the source node.

The indication information is used to indicate whether a source secondary node releases only the terminal context, which corresponds to the user side device on a secondary cell group associated with a source master cell group in the source master node, in the source secondary node. It is to be noted that whether the master cell group and the secondary cell group have an association relationship is determined by whether the master cell group and the secondary cell group are included in the candidate cell groups corresponding to the same cell group selective activation. In the case where the master cell group and the secondary cell group are included in the candidate cell groups corresponding to the same cell group selective activation, the master cell group and the secondary cell group have the association relationship (i.e., they are associated with each other); in the case where the master cell group and the secondary cell group are not included in the candidate cell groups corresponding to the same cell group selective activation, the master cell group and the secondary cell group do not have the association relationship (i.e., they are not associated with each other).

The indication information is used to indicate whether the source secondary node releases only the terminal context related to connection with the service node in the source secondary node. As can be seen from the foregoing, the service node can be a target master node, and correspondingly, the indication information here is used to indicate whether the source secondary node releases only the terminal context related to the connection with the target master node in the source secondary node.

Through the above method, a range of the terminal context to be released can be determined based on the indication information in the inter-node message, and resource release is performed according to the terminal context to be released as indicated by the indication information, thereby reducing the resource occupancy by the user side device at the source node.

In some embodiments, the source node is a source secondary node, and the cell group corresponding to the mobility operation (i.e., the candidate cell group) includes a candidate master cell group and a candidate secondary cell group. If a first preset condition is met, the indication information is used to indicate the source secondary node to release only the terminal context of the user side device in the source secondary node that is related to the connection with the service master node.

As can be seen from the foregoing, that the cell groups corresponding to the same mobility operation include the candidate master cell group and the candidate secondary cell group indicates that there is an association relationship between the candidate master cell group and the candidate secondary cell group.

The service node can be a service master node, and the first preset condition includes that the service master node is not configured with a candidate master cell group of the candidate cell groups, or the service master node is configured with a candidate master cell group of the candidate cell groups and the source secondary node is not a secondary node corresponding to a candidate secondary cell group associated with the candidate master cell group of the candidate cell groups.

In an implementation, the indication information may be carried in a secondary node release request message. After receiving the secondary node release request message, the source secondary node performs the terminal context release according to the indication information in the secondary node release request message.

In an implementation, after receiving the terminal context release message, the source secondary node performs the terminal context release according to the indication information in the secondary node release request message, where the secondary node release request message may be an inter-node message received before the terminal context release message is received.

In an implementation, in a case where the master cell group change occurs in the user side device, the service master node may be a target master node, that is, the target master node sends a secondary node release request message or a terminal context release message to the source secondary node.

In an implementation, in a case where the secondary cell group change occurs in the user side device, the service master node may be a master node connected with the user side device that is not changed before and after the secondary cell group change, and the master node sends a secondary node release request message or a terminal context release message to the source secondary node.

Through the above method, the joint configuration of MCG and SCG can be guaranteed to be available subsequently, and at the same time, there will not be waste of resources due to retaining all resources.

In some embodiments, the source node is a source secondary node, and the cell group corresponding to the mobility operation (i.e., the candidate cell group) includes a candidate master cell group and a candidate secondary cell group. In a case where a second preset condition is met, the service master node does not need to send a terminal context release message or a secondary node release request message to the source secondary node.

As can be seen from the foregoing, that the cell groups corresponding to the same mobility operation includes the candidate master cell group and the candidate secondary cell group is used to indicate that there is an association relationship between the candidate master cell group and the candidate secondary cell group.

The service node may be a service master node, and the second preset condition includes that the service master node is configured with a candidate master cell group of the candidate cell groups, and the source secondary cell group in the source secondary node is a candidate secondary cell group associated with the candidate master cell group of the candidate cell groups.

In an implementation, in a case where the master cell group change occurs in the user side device, the service master node may be a target master node, that is, the target master node does not need to send a terminal context release message or a secondary node release request message to the source secondary node.

In an implementation, in a case where the secondary cell group change occurs in the user side device, the service master node can be the master node that is connected to the user side device and is not changed before and after the secondary cell group change. The master node does not need to send a terminal context release message or a secondary node release request message to the source secondary node.

Through the above method, in a case where the second preset condition is met, indicating that the source secondary node is configured with the cell group corresponding to the mobility operation, correspondingly, the source secondary node needs to support UE access, and therefore, the terminal context corresponding to the user side device in the source secondary node can be retained, that is, the source secondary node does not need to release the terminal context, and thus, the service master node does not need to send to the source secondary node a terminal context release message or an secondary node release request message that is used to indicate the source secondary node to perform the terminal context release.

In some embodiments, the source node is a source secondary node, and the cell groups corresponding to the mobility operation (i.e., the candidate cell groups) include a candidate master cell group and a candidate secondary cell group. In a case where a third preset condition is met, the indication information is used to indicate the source secondary node to release the terminal context corresponding to the user side device in the source secondary cell group in the source secondary node.

As can be seen from the foregoing, that the cell groups corresponding to the same mobility operation include the candidate master cell group and the candidate secondary cell group is used to indicate that there is an association relationship between the candidate master cell group and the candidate secondary cell group.

The third preset condition includes that the service master node is configured with a candidate master cell group of candidate cell groups, the source secondary node is a secondary node corresponding to a candidate secondary cell group associated with the candidate master cell group, and a source secondary cell group in the source secondary node is not a candidate secondary cell group associated with the candidate master cell group.

In an implementation, the indication information may be carried in a secondary node release request message. After receiving the secondary node release request message, the source secondary node performs the terminal context release according to the indication information in the secondary node release request message.

In an implementation, in a case where the master cell group change occurs in the user side device, the service master node may be a target master node, that is, the target master node sends the inter-node message carrying the indication information to the source secondary node.

In an implementation, in a case where the secondary cell group change occurs in the user side device, the service master node may be a master node that is connected with the user side device and is not changed before and after the secondary cell group change. The master node sends the inter-node message carrying the indication information to the source secondary node.

Through the above method, the joint configuration of MCG and SCG is guaranteed to be available subsequently, and the source SN releases only the UE context related to the SCG that is not a candidate cell group, which will not affect the selective activation configuration of the cell group, and at the same time, there will not be waste of resources due to retaining all resources.

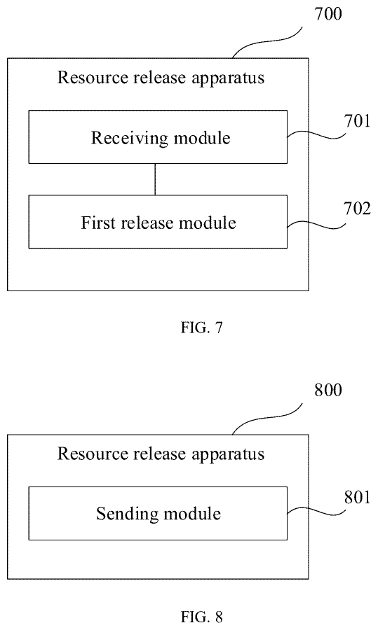

FIG. 7 is a block diagram of a resource release apparatus according to an illustrative embodiment. The resource release apparatus is applied to a source node. Referring to FIG. 7, the resource release apparatus 700 includes:
a receiving module 701, configured to receive an inter-node message sent by a service node, where the source node is a network node that supports a user side device to perform communication before cell change occurs in the user side device, the service node is a network node that supports the user side device to perform communication after the cell change occurs in the user side device, the user side device is configured with a mobility operation, and the mobility operation includes selective activation of a cell group; and
a first release module 702, configured to perform terminal context release according to the inter-node message.

In some examples, the source node includes a source master node and/or a source secondary node.

In some examples, the inter-node message carries indication information, where the indication information is used to indicate at least one of the following:
to indicate whether target terminal context corresponding to the user side device on a source cell group in the source node needs to be released/retained;
to indicate whether the terminal context corresponding to the user side device on a source cell group in the source node needs to be released/retained;
to indicate whether the terminal context corresponding to the user side device on all candidate cell groups in the source node needs to be released/retained;
to indicate whether the terminal context corresponding to the user side device on a first target candidate cell group in the source node needs to be released/retained;
to indicate whether the source secondary node releases only the terminal context corresponding to the user side device on a secondary cell group, that is associated with a source master cell group in the source master node, in the source secondary node; or
to indicate whether the source secondary node releases only the terminal context related to connection with the service node in the source secondary node.

In some examples, the inter-node message includes a terminal context release message, and the resource release apparatus 700 further includes:
a second release module, configured to perform the terminal context release according to indication information carried in another inter-node message before the source node receives the inter-node message.

In some examples, the inter-node message includes terminal context release information, the cell group corresponding to the mobility operation is a candidate cell group, and the first release module 702 includes:
a first release sub-module, configured to perform the terminal context release according to whether the source node is configured with the candidate cell group in response to the received inter-node message.

In some examples, the source node includes a source master node, the cell change includes a master cell group change, the candidate cell group includes multiple candidate master cell groups, and the first release sub-module is configured to, in response to the received inter-node message, in a case where the master cell group change occurs in the user side device and the source master node is configured with at least one of the candidate master cell groups, retain the terminal context corresponding to the user side device on the candidate master cell group in the source master node.

In some examples, the first release sub-module is configured to release the terminal context corresponding to the user side device in the source master node in response to the received inter-node message in a case where the master cell group change occurs in the user side device and the source master node is not configured with at least one of the candidate master cell groups.

In some examples, the source node further includes a source secondary node, the cell change includes a master cell group change and a secondary cell group change, the candidate cell group includes multiple candidate secondary cell groups, and the first release sub-module is configured to perform at least one of the following:
in response to the received inter-node message, in a case where the master cell group change occurs in the user side device and the source secondary node is configured with at least one of the candidate secondary cell groups, retain the terminal context corresponding to the user side device on the candidate secondary cell group in the source secondary node; or
in response to the received inter-node message, in a case where the secondary cell group change occurs in the user side device and the source secondary node is configured with at least one of the candidate secondary cell groups, retain the terminal context corresponding to the user side device on the candidate secondary cell group in the source secondary node.

In some examples, the first release sub-module is configured to perform at least one of the following:
in response to the received inter-node message, in a case where the master cell group change occurs in the user side device and the candidate secondary cell group in the source secondary node is associated with a candidate master cell group in the source master node, retain the terminal context corresponding to signaling connection between the source secondary node and the source master node related to the user side device in the source secondary node; or
in response to the received inter-node message, in a case where the secondary cell group change occurs in the user side device and the candidate secondary cell group in the source secondary node is associated with a candidate master cell group in the source master node, retain the terminal context corresponding to signaling connection between the source secondary node and the source master node related to the user side device in the source secondary node.

In some examples, the first release sub-module is configured to perform at least one of the following:
in response to the received inter-node message, in a case where the master cell group change occurs in the user side device and there is no association relationship between the candidate secondary cell group in the source secondary node and a candidate master cell group in the source master node, release only the terminal context corresponding to signaling connection between the source secondary node and the source master node related to the user side device in the source secondary node; or
in response to the received inter-node message, in a case where the secondary cell group change occurs in the user side device and there is no association relationship between the candidate secondary cell group in the source secondary node and a candidate master cell group in the source master node, release only the terminal context corresponding to signaling connection between the source secondary node and the source master node related to the user side device in the source secondary node.

In some examples, the first release sub-module is configured to perform at least one of the following:
in response to the received inter-node message, in a case where the master cell group change occurs in the user side device and the source secondary node is not configured with at least one of the candidate secondary cell groups, release the terminal context corresponding to the user side device in the source secondary node; or
in response to the received inter-node message, in a case where the secondary cell group change occurs in the user side device and the source secondary node is not configured with at least one of the candidate secondary cell groups, release the terminal context corresponding to the user side device in the source secondary node.

In some examples, whether there is an association relationship between the master cell group and the secondary cell group is determined by whether the master cell group and the secondary cell group are included in the candidate cell groups corresponding to the same selective activation of the cell groups.

In some examples, the source node includes a source secondary node, the candidate cell groups include a candidate master cell group and a candidate secondary cell group, and in a case where a first preset condition is met, the indication information is used to indicate the source secondary node to release only the terminal context of the user side device related to connection with the service node in the source secondary node.

The first preset condition includes that the service node is not configured with the candidate master cell group of the candidate cell groups, or the service node is configured with a candidate master cell group of the candidate cell groups and the source secondary node is not a secondary node corresponding to a candidate secondary cell group associated with the candidate master cell group of the candidate cell groups.

In some examples, the source node includes a source secondary node, the candidate cell groups include a candidate master cell group and a candidate secondary cell group, and in a case where a second preset condition is met, the service node does not need to send the terminal context release message or the secondary node release request message to the source secondary node.

The second preset condition includes that the service node is configured with the candidate master cell group of the candidate cell groups, and a source secondary cell group in the source secondary node is a candidate secondary cell group associated with the candidate master cell group of the candidate cell groups.

In some examples, the source node includes a source secondary node, the candidate cell groups include a candidate master cell group and a candidate secondary cell group, and in a case where a third preset condition is met, the indication information is used to indicate the source secondary node to release the terminal context corresponding to the user side device in a source secondary cell group in the source secondary node.

The third preset condition includes that the service node is configured with the candidate master cell group of the candidate cell groups, the source secondary node is a secondary node corresponding to a candidate secondary cell group associated with the candidate master cell group, and a source secondary cell group in the source secondary node is not the candidate secondary cell group associated with the candidate master cell group.

FIG. 8 is a block diagram showing a resource release apparatus according to an illustrative embodiment. The resource release apparatus 800 is applied to a service node, and includes:
a sending module 801, configured to send an inter-node message to a source node;
where the source node is a network node that supports a user side device to perform communication before a cell change occurs in the user side device, the service node is a network node that supports the user side device to perform communication after the cell change occurs in the user side device, the user side device is configured with a mobility operation, the mobility operation includes selective activation of cell groups, and the inter-node message is used to indicate the source node to perform terminal context release.

In some examples, the inter-node message carries indication information, where the indication information is used to indicate at least one of the following:
to indicate whether target terminal context corresponding to the user side device on a source cell group in the source node needs to be released/retained;
to indicate whether the terminal context corresponding to the user side device on a source cell group in the source node needs to be released/retained;
to indicate whether the terminal context corresponding to the user side device on all candidate cell groups in the source node needs to be released/retained;
to indicate whether the terminal context corresponding to the user side device on a first target candidate cell group in the source node needs to be released/retained;
to indicate whether the source secondary node releases only the terminal context corresponding to the user side device on a secondary cell group, that is associated with a source master cell group in the source master node, in the source secondary node; or
to indicate whether the source secondary node releases only the terminal context related to connection with the service node in the source secondary node.

In some examples, the source node includes a source secondary node, the candidate cell groups include a candidate master cell group and a candidate secondary cell group, and in a case where a first preset condition is met, the indication information is used to indicate the source secondary node to release only the terminal context of the user side device related to connection with the service node in the source secondary node.

The first preset condition includes that the service node is not configured with the candidate master cell group of the candidate cell groups, or the service node is configured with the candidate master cell group of the candidate cell groups and the source secondary node is not a secondary node corresponding to a candidate secondary cell group associated with the candidate master cell group of the candidate cell groups.

In some examples, the source node includes a source secondary node, the candidate cell groups include a candidate master cell group and a candidate secondary cell group, and in a case where a second preset condition is met, the service node does not need to send the terminal context release message or the secondary node release request message to the source secondary node.

The second preset condition includes that the service node is configured with the candidate master cell group of the candidate cell groups, and a source secondary cell group in the source secondary node is a candidate secondary cell group associated with the candidate master cell group of the candidate cell groups.

In some examples, the source node includes a source secondary node, the candidate cell groups include a candidate master cell group and a candidate secondary cell group, and in a case where a third preset condition is met, the indication information is used to indicate the source secondary node to release the terminal context corresponding to the user side device in a source secondary cell group in the source secondary node;
The third preset condition includes that the service node is configured with the candidate master cell group of the candidate cell groups, the source secondary node is a secondary node corresponding to a candidate secondary cell group associated with the candidate master cell group, and a source secondary cell group in the source secondary node is not the candidate secondary cell group associated with the candidate master cell group.

Regarding the apparatus in the above embodiments, the specific manner in which the modules performs operations has been described in detail in the method embodiments, which will not be detailed here.

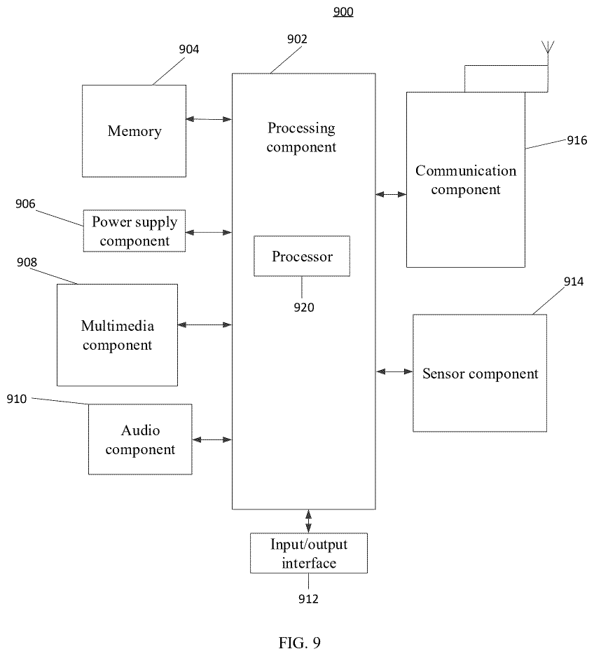

FIG. 9 is a block diagram showing a resource release apparatus according to an illustrative embodiment. The resource release apparatus 900 may be a user side device, and the user side device may be a mobile phone, a computer, a digital broadcast terminal, a messaging device, a game console, a tablet device, a medical device, a fitness device, a personal digital assistant, etc.

Referring to FIG. 9, the resource release apparatus 900 may include one or more of the following components: a processing component 902, a memory 904, a power supply component 906, a multimedia component 908, an audio component 910, an input/output interface 912, a sensor component 914, and a communication component 916.

The processing component 902 generally controls the overall operation of the resource release apparatus 900, such as operations associated with display, phone calls, data communications, camera operations, and recording operations. The processing component 902 may include one or more processors 920 to execute instructions to complete all or part of the steps of the resource release method. In addition, the processing component 902 may include one or more modules to facilitate the interaction between the processing component 902 and other components. For example, the processing component 902 may include a multimedia module to facilitate the interaction between the multimedia component 908 and the processing component 902.

The memory 904 is configured to store various types of data to support operations on the resource release apparatus 900. Examples of such data include instructions for any application or method operating on the resource release apparatus 900, contact data, phone book data, messages, pictures, videos, etc. The memory 904 can be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power supply component 906 provides power to various components of the resource release apparatus 900. The power supply component 906 may include a power management system, one or more power supplies, and other components associated with generating, managing, and distributing power for the resource release apparatus 900.

The multimedia component 908 includes a screen that provides an output interface between the resource release apparatus 900 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, slide, and gestures on the touch panel. The touch sensor may not only sense the boundaries of the touch or slide action, but also detect the duration and pressure associated with the touch or slide operation. In some embodiments, the multimedia component 908 includes a front camera and/or a rear camera. When the resource release apparatus 900 is in an operating mode, such as a shooting mode or a video mode, the front camera and/or the rear camera may receive external multimedia data. Each front camera and rear camera may be a fixed optical lens system or have a focal length and optical zoom capability.

The audio component 910 is configured to output and/or input audio signals. For example, the audio component 910 includes a microphone (MIC), and when the resource release apparatus 900 is in an operating mode, such as a call mode, a recording mode, and a speech recognition mode, the microphone is configured to receive an external audio signal. The received audio signal can be further stored in the memory 904 or sent via the communication component 916. In some embodiments, the audio component 910 also includes a speaker for outputting audio signals.

The input/output interface 912 provides an interface between the processing component 902 and the peripheral interface modules, which may be a keyboard, a click wheel, buttons, etc. These buttons may include but are not limited to: a home button, a volume button, a start button, and a lock button.

The sensor component 914 includes one or more sensors for providing various aspects of status assessment for the resource release apparatus 900. For example, the sensor component 914 can detect the open/closed state of the resource release apparatus 900, the relative positioning of the components, such as the display and keypad of the apparatus 900, and the sensor component 914 can also detect change in the position of the resource release apparatus 900 or a component of the resource release apparatus 900, the presence or absence of user contact with the resource release apparatus 900, the orientation or acceleration/deceleration of the resource release apparatus 900, and change in the temperature of the resource release apparatus 900. The sensor component 914 may include a proximity sensor configured to detect the presence of a nearby object without any physical contact. The sensor component 914 may also include an optical sensor, such as a CMOS or CCD image sensor, for use in imaging applications. In some embodiments, the sensor component 914 may also include an acceleration sensor, a gyroscope sensor, a magnetic sensor, a pressure sensor, or a temperature sensor.

The communication component 916 is configured to facilitate wired or wireless communication between the resource release apparatus 900 and other devices. The resource release apparatus 900 can access a wireless network based on a communication standard, such as Wi-Fi, 2G or 3G, or a combination thereof. In an illustrative embodiment, the communication component 916 receives a broadcast signal or broadcast-related information from an external broadcast management system via a broadcast channel. In an illustrative embodiment, the communication component 916 also includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an illustrative embodiment, the resource release apparatus 900 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic components to implement the resource release method.

In an illustrative embodiment, a non-transitory computer-readable storage medium including instructions is also provided, such as a memory 904 including instructions, and the instructions can be executed by a processor 920 of the resource release apparatus 900 to complete the resource release method. For example, the non-transitory computer-readable storage medium can be a ROM, a random access memory (RAM), a CD-ROM, a magnetic tape, a floppy disk, an optical data storage device, etc.

In addition to serving as an independent user side device, the resource release apparatus can also be a part of an independent user side device. For example, in an embodiment, the apparatus can be an integrated circuit (IC) or a chip, where the integrated circuit can be an IC or a collection of multiple ICs; the chip can include but is not limited to the following types: a Graphics Processing Unit (GPU), a Central Processing Unit (CPU), a Field Programmable Gate Array (FPGA), a Digital Signal Processor (DSP), an Application Specific Integrated Circuit (ASIC), a System on Chip (SoC) or a system-level chip, etc. The above integrated circuit or chip can be used to execute executable instructions (or codes) to implement the above resource release method. The executable instructions can be stored in the integrated circuit or chip, or can be obtained from other devices or equipment, for example, the integrated circuit or chip includes a processor, a memory, and an interface for communicating with other devices. The executable instructions may be stored in the processor, and when the executable instruction is executed by the processor, the above resource release method is implemented; alternatively, the integrated circuit or chip may receive the executable instructions through the interface and transmit them to the processor for execution to implement the above resource release method.

In another illustrative embodiment, there is also provided a computer program product including a computer program executable by a programmable device. The computer program has code portions which, when being executed by the programmable device, perform the above resource release method.

In another illustrative embodiment, a chip is provided, including a processor and an interface. The processor is configured to read instructions to perform the above resource release method.

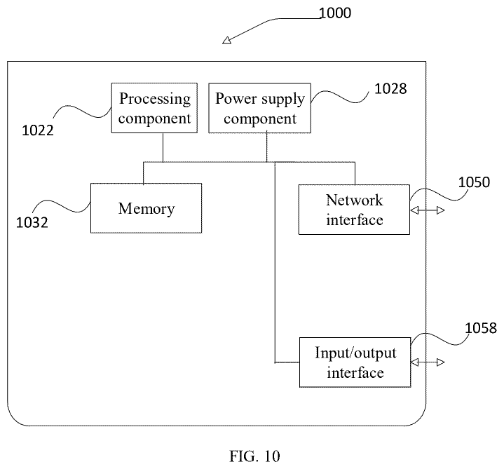

FIG. 10 is a block diagram showing a resource release apparatus according to an illustrative embodiment. The resource release apparatus 1000 may be a service node, and the resource release apparatus 1000 may be provided as a network device. Referring to FIG. 10, the resource release apparatus 1000 includes a processing component 1022, which further includes one or more processors, and a memory resource represented by a memory 1032 configured to store instructions executable by the processing component 1022, such as an application. The application stored in the memory 1032 may include one or more modules, each of which corresponds to a set of instructions. In addition, the processing component 1022 is configured to execute instructions to perform the above resource release method.

The resource release apparatus 1000 may further include a power supply component 1026 configured to perform power management for the resource release apparatus 1000, a wired or wireless network interface 1050 configured to connect the resource release apparatus 1000 to a network, and an input/output interface 1058.

Those skilled in the art will readily appreciate other embodiments of the present disclosure after considering the specification and practicing the present disclosure. The present disclosure is intended to cover any variations, uses or adaptations of the present disclosure, which follow the general principles of the present disclosure and include common knowledge or customary technical means in the art that are not disclosed in the present disclosure. The specification and embodiments are to be considered as illustrative only, and the true scope and spirit of the present disclosure are indicated by the following claims.

It should be understood that the present disclosure is not limited to the exact structures that have been described above and shown in the drawings, and that various modifications and changes may be made without departing from the scope thereof. The scope of the present disclosure is limited only by the appended claims.

1. A resource release method, applied to a source node, the method comprising:
receiving an inter-node message sent by a service node, wherein the source node is a network node that supports a user side device to perform communication before a cell change occurs in the user side device, the service node is a network node that supports the user side device to perform communication after the cell change occurs in the user side device, the user side device is configured with a mobility operation, and the mobility operation comprises selective activation of a cell group; and
performing terminal context release according to the inter-node message.

2. The method according to claim 1, wherein the source node comprises at least one of a source master node and/or a source secondary node-,
wherein the inter-node message carries indication information, and the indication information is configured to indicate at least one of the following:
whether to release or retain target terminal context corresponding to the user side device on a source cell group in the source node;
whether to release or retain the terminal context corresponding to the user side device on a source cell group in the source node;
whether to release or retain the terminal context corresponding to the user side device on all candidate cell groups in the source node;
whether to release or retain the terminal context corresponding to the user side device on a first target candidate cell group in the source node;
whether to release the terminal context related to resources corresponding to the user side device on a source cell in the source node;
whether the source secondary node releases only the terminal context corresponding to the user side device on a secondary cell group, that is associated with a source master cell group in the source master node, in the source secondary node; or
whether the source secondary node releases only the terminal context related to connection with the service node in the source secondary node.

3. (canceled)

4. The method according to claim 1, wherein the inter-node message comprises a terminal context release message, and the method further comprises:
performing the terminal context release according to indication information carried in another inter-node message before the source node receives the inter-node message.

5. The method according to claim 1, wherein the inter-node message comprises a terminal context release message, the cell group corresponding to the mobility operation is a candidate cell group, and performing the terminal context release according to the inter-node message comprises:
in response to receiving the inter-node message, performing the terminal context release according to whether the source node is configured with the candidate cell group.

6. The method according to claim 5, wherein the source node comprises a source master node, the cell change comprises a master cell group change, the candidate cell group comprises a plurality of candidate master cell groups, and the performing the terminal context release according to whether the source node is configured with the candidate cell group in response to receiving the inter-node message comprises:
in response to receiving the inter-node message, in a case where the master cell group change occurs in the user side device and the source master node is configured with at least one of the candidate master cell groups, retaining the terminal context corresponding to the user side device on the candidate master cell group in the source master node.

7. The method according to claim 6, wherein the performing the terminal context release according to whether the source node is configured with the candidate cell group in response to receiving the inter-node message comprises:
in response to receiving the inter-node message, in a case where the master cell group change occurs in the user side device and the source master node is not configured with at least one of the candidate master cell groups, releasing the terminal context corresponding to the user side device in the source master node.

8. The method according to claim 6, wherein the source node further comprises a source secondary node, the cell change comprises a master cell group change and a secondary cell group change, the candidate cell group comprises a plurality of candidate secondary cell groups, and the performing the terminal context release according to whether the source node is configured with the candidate cell group in response to receiving the inter-node message comprises at least one of the following:
in response to receiving the inter-node message, in a case where the master cell group change occurs in the user side device and the source secondary node is configured with at least one of the candidate secondary cell groups, retaining the terminal context corresponding to the user side device on the candidate secondary cell group in the source secondary node; or
in response to receiving the inter-node message, in a case where the secondary cell group change occurs in the user side device and the source secondary node is configured with at least one of the candidate secondary cell groups, retaining the terminal context corresponding to the user side device on the candidate secondary cell group in the source secondary node.

9. The method according to claim 8, wherein the performing the terminal context release according to whether the source node is configured with the candidate cell group in response to receiving the inter-node message comprises at least one of the following:
in response to receiving the inter-node message, in a case where the master cell group change occurs in the user side device and the candidate secondary cell group in the source secondary node has an association relationship with a candidate master cell group in the source master node, retaining the terminal context corresponding to signaling connection between the source secondary node and the source master node related to the user side device in the source secondary node; or
in response to receiving the inter-node message, in a case where the secondary cell group change occurs in the user side device and the candidate secondary cell group in the source secondary node has an association relationship with a candidate master cell group in the source master node, retaining the terminal context corresponding to signaling connection between the source secondary node and the source master node related to the user side device in the source secondary node,
wherein whether the master cell group and the secondary cell group have the association relationship is determined by whether the master cell group and the secondary cell group are comprised in the candidate cell groups corresponding to the same selective activation of the cell group.

10. The method according to claim 8, wherein the performing the terminal context release according to whether the source node is configured with the candidate cell group in response to receiving the inter-node message comprises at least one of the following:
in response to receiving the inter-node message, in a case where the master cell group change occurs in the user side device and the candidate secondary cell group in the source secondary node does not have an association relationship with a candidate master cell group in the source master node, releasing only the terminal context corresponding to signaling connection between the source secondary node and the source master node related to the user side device in the source secondary node; or
in response to receiving the inter-node message, in a case where the secondary cell group change occurs in the user side device and the candidate secondary cell group in the source secondary node does not have an association relationship with a candidate master cell group in the source master node, releasing only the terminal context corresponding to signaling connection between the source secondary node and the source master node related to the user side device in the source secondary node,
wherein whether the master cell group and the secondary cell group have the association relationship is determined by whether the master cell group and the secondary cell group are comprised in the candidate cell groups corresponding to the same selective activation of the cell group.

11. The method according to claim 9, wherein the performing the terminal context release according to whether the source node is configured with the candidate cell group in response to receiving the inter-node message comprises at least one of the following:
in response to receiving the inter-node message, in a case where the master cell group change occurs in the user side device and the source secondary node is not configured with at least one of the candidate secondary cell groups, releasing the terminal context corresponding to the user side device in the source secondary node; or
in response to receiving the inter-node message, in a case where the secondary cell group change occurs in the user side device and the source secondary node is not configured with at least one of the candidate secondary cell groups, releasing the terminal context corresponding to the user side device in the source secondary node.

12. (canceled)

13. The method according to claim 123, wherein the source node comprises a source secondary node, the candidate cell group comprises a candidate master cell group and a candidate secondary cell group, and in a case where a first preset condition is met, the indication information is configured to indicate the source secondary node to release only the terminal context of the user side device in the source secondary node that is related to the connection with the service node; and
the first preset condition comprises that the service node is not configured with the candidate master cell group of the candidate cell group, or that the service node is configured with the candidate master cell group of the candidate cell group and the source secondary node is not a secondary node corresponding to a candidate secondary cell group associated with the candidate master cell group of the candidate cell group.

14. The method according to claim 3, wherein the source node comprises a source secondary node, the candidate cell group comprises a candidate master cell group and a candidate secondary cell group, and in a case where a second preset condition is met, the service node does not send the inter-node message to the source secondary node; and
the second preset condition comprises that the service node is configured with the candidate master cell group of the candidate cell group, and a source secondary cell group in the source secondary node is a candidate secondary cell group associated with the candidate master cell group of the candidate cell group.

15. The method according to claim 3, wherein the source node comprises a source secondary node, the candidate cell group comprises a candidate master cell group and a candidate secondary cell group, and in a case where a third preset condition is met, the indication information is configured to indicate the source secondary node to release the terminal context corresponding to the user side device in a source secondary cell group in the source secondary node; and
the third preset condition comprises that the service node is configured with the candidate master cell group of the candidate cell group, the source secondary node is a secondary node corresponding to the candidate secondary cell group associated with the candidate master cell group, and a source secondary cell group in the source secondary node is not the candidate secondary cell group associated with the candidate master cell group.

16. A resource release method, applied to a service node, the method comprising:
sending an inter-node message to a source node;
wherein the source node is a network node that supports a user side device to perform communication before a cell change occurs in the user side device, the service node is a network node that supports the user side device to perform communication after the cell change occurs in the user side device, the user side device is configured with a mobility operation, the mobility operation comprises selective activation of a cell group, and the inter-node message is configured to indicate the source node to perform terminal context release.

17. The method according to claim 16, wherein the inter-node message carries indication information, and the indication information is configured to indicate at least one of the following:
whether to release or retain target terminal context corresponding to the user side device on a source cell group in the source node;
whether to release or retain the terminal context corresponding to the user side device on a source cell group in the source node;
whether to release or retain the terminal context corresponding to the user side device on all candidate cell groups in the source node;
whether to release or retain the terminal context corresponding to the user side device on a first target candidate cell group in the source node;
whether to release the UE context related to resources corresponding to the user side device on a source cell in the source node;
whether a source secondary node releases only the terminal context corresponding to the user side device on a secondary cell group, that is associated with a source master cell group in the source master node, in the source secondary node; or
whether the source secondary node releases only the terminal context related to connection with the service node in the source secondary node.

18. The method according to claim 17, wherein the source node comprises a source secondary node, the candidate cell group comprises a candidate master cell group and a candidate secondary cell group, and in a case where a first preset condition is met, the indication information is configured to indicate the source secondary node to release only the terminal context of the user side device in the source secondary node that is related to the connection with the service node; and
the first preset condition comprises that the service node is not configured with the candidate master cell group of the candidate cell group, or that the service node is configured with the candidate master cell group of the candidate cell group, and the source secondary node is not a secondary node corresponding to a candidate secondary cell group associated with the candidate master cell group of the candidate cell group.

19. The method according to claim 17, wherein the source node comprises a source secondary node, the candidate cell group comprises a candidate master cell group and a candidate secondary cell group, and in a case where a second preset condition is met, the service node does not send the inter-node message to the source secondary node; and
the second preset condition comprises that the service node is configured with the candidate master cell group of the candidate cell group, and a source secondary cell group in the source secondary node is a candidate secondary cell group associated with the candidate master cell group of the candidate cell group.

20. The method according to claim 17, wherein the source node comprises a source secondary node, the candidate cell group comprises a candidate master cell group and a candidate secondary cell group, and in a case where a third preset condition is met, the indication information is configured to indicate the source secondary node to release the terminal context corresponding to the user side device in a source secondary cell group in the source secondary node; and
the third preset condition comprises that the service node is configured with the candidate master cell group of the candidate cell group, the source secondary node is a secondary node corresponding to the candidate secondary cell group associated with the candidate master cell group, and a source secondary cell group in the source secondary node is not the candidate secondary cell group associated with the candidate master cell group.

21-22. (canceled)

23. A resource release apparatus, applied to a source node, the apparatus comprising:
a processor; and
a memory configured to store instructions executable by the processor;
wherein the processor is configured to perform a resource release method, the method comprising:
receiving an inter-node message sent by a service node, wherein the source node is a network node that supports a user side device to perform communication before a cell change occurs in the user side device, the service node is a network node that supports the user side device to perform communication after the cell change occurs in the user side device, the user side device is configured with a mobility operation, and the mobility operation comprises selective activation of a cell group; and
performing terminal context release according to the inter-node message.

24. (canceled)

25. A resource release apparatus, applied to a service node, the apparatus comprising:
a processor; and
a memory configured to store instructions executable by the processor;
wherein the processor is configured to perform the method according to claim 16.
